(19) United States
(12) Patent Application Publication
(10) Pub. No.: US 2023/0376272 A1
(43) Pub. Date: Nov. 23, 2023

(54) FAST EIGHT-BIT FLOATING POINT (FP8) SIMULATION WITH LEARNABLE PARAMETERS

(71) Applicant: QUALCOMM Incorporated, San Diego, CA (US)

(72) Inventors: Marinus Willem VAN BAALEN, Amsterdam (NL); Jorn Wilhelmus Timotheus PETERS, Amsterdam (NL); Markus NAGEL, Amsterdam (NL); Tijmen Pieter Frederik BLANKEVOORT, Amsterdam (NL); Andrey KUZMIN, Amsterdam (NL)

(21) Appl. No.: 18/102,582

(22) Filed: Jan. 27, 2023

Related U.S. Application Data
(60) Provisional application No. 63/343,968, filed on May 19, 2022.

(51) Int. Cl. G06F 7/483; G06F 5/01

(52) U.S. Cl. CPC G06F 7/483; G06F 5/012

(57) ABSTRACT

A processor-implemented method for fast floating point simulations with learnable parameters includes receiving a single precision input. An integer quantization process is performed on the input. Each element of the input is scaled based on a scaling parameter to generate an m-bit floating point output, where m is an integer.

### CROSS-REFERENCE TO RELATED APPLICATION

The present application claims the benefit of U.S. Provisional Patent Application No. 63/343,968, filed on May 19, 2022, and titled “FAST EIGHT-BIT FLOATING POINT (FP8) SIMULATION WITH LEARNABLE PARAMETERS,” the disclosure of which is expressly incorporated by reference in its entirety.

### FIELD OF THE DISCLOSURE

Aspects of the present disclosure generally relate to floating point simulation with learnable parameters.

### BACKGROUND

Artificial neural networks may comprise interconnected groups of artificial neurons (e.g., neuron models). The artificial neural network may be a computational device or be represented as a method to be performed by a computational device. Convolutional neural networks (CNNs) are a type of feed-forward artificial neural network. Convolutional neural networks may include collections of neurons that each have a receptive field and that collectively tile an input space. Convolutional neural networks such as deep convolutional neural networks (DCNs), have numerous applications. In particular, these neural network architectures are used in various technologies, such as image recognition, speech recognition, acoustic scene classification, keyword spotting, autonomous driving, and other classification tasks.

Deep neural networks have grown in popularity because of their ability to solve complex problems. As such, deep learning deployment on edge devices for real time inference is an area of interest. Unfortunately, the model size and thus memory consumption and complexity may be prohibitively large with millions of parameters.

### SUMMARY

The present disclosure is set forth in the independent claims, respectively. Some aspects of the disclosure are described in the dependent claims.

In one aspect of the present disclosure, a processor-implemented method includes receiving an input. The processor-implemented method further includes performing an integer quantization process on the input. Each element of the input is scaled based on a scaling parameter to generate an m-bit floating point output, where m is an integer.

Another aspect of the present disclosure is directed to an apparatus including means for receiving an input. The apparatus further includes means for performing an integer quantization process on the input. Each element of the input is scaled based on a scaling parameter to generate an m-bit floating point output, where m is an integer.

In another aspect of the present disclosure, a non-transitory computer-readable medium with non-transitory program code recorded thereon is disclosed. The program code is executed by a processor and includes program code to receive an input. The program code further includes program code to perform an integer quantization process on the input. Each element of the input is scaled based on a scaling parameter to generate an m-bit floating point output, where m is an integer.

Another aspect of the present disclosure is directed to an apparatus having a memory and one or more processors coupled to the memory. The processor(s) is configured to receive an input. The processor(s) is further configured to perform an integer quantization process on the input. Each element of the input is scaled based on a scaling parameter to generate an m-bit floating point output, where m is an integer.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor, in accordance with certain aspects of the present disclosure.

FIGS. 2A, 2B, and 2C are diagrams illustrating a neural network, in accordance with aspects of the present disclosure.

FIG. 2D is a diagram illustrating an exemplary deep convolutional network (DCN), in accordance with aspects of the present disclosure.

FIG. 3 is a block diagram illustrating an exemplary deep convolutional network (DCN), in accordance with aspects of the present disclosure.

FIG. 4 is a block diagram illustrating an exemplary software architecture that may modularize artificial intelligence (AI) functions, in accordance with aspects of the present disclosure.

FIG. 5 is a block diagram illustrating example pseudo code, in accordance with aspects of the present disclosure.

FIG. 6 is a flow diagram illustrating a processor-implemented method for eight-bit floating point simulation with learnable parameters, in accordance with aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

As described, deep neural networks have grown in popularity because of their ability to solve complex problems. As such, deep learning deployment on edge devices for real time inference is an area of interest. Unfortunately, the model size and thus memory consumption and complexity may be prohibitively large with millions of parameters.

Neural network quantization is one effective way to improve the efficiency of neural networks. In neural network quantization, weights and activations may be represented in low bit-width formats, such as, eight-bit integers (INT8), for example. When executing networks on any device, neural network quantization (hereinafter referred to as “quantization”) may lead to a reduction in data movement and enable the use of low bit-width computations, thus yielding significantly faster inference with reduced energy consumption.

In general, values in neural networks may be represented in either integer (INT) or floating-point (FP) formats. Conventional approaches to address this inefficiency have used 16-bit precision in an effort to reduce energy and memory consumption. However, despite such advancements, conventional approaches produce models with memory consumption that remain prohibitively large. Furthermore, training and simulation of models with parameters that are represented with less than 16 bits has been challenging. Conventional approaches for eight-bit floating point (FP8) simulation are time consuming or complex and difficult to adapt. Moreover, such conventional approaches do not allow definition of gradients with respect to FP8 parameters, thus making range learning challenging.

Accordingly, to address these and other challenges, aspects of the present disclosure are directed to an arbitrary bit-width simulation with learnable parameters. In some aspects, an eight-bit floating point simulation with learnable parameters is described, for example. In accordance with aspects of the present disclosure, eight-bit floating point quantization may enable post-training quantization (PTQ) and quantization aware training (QAT) experiments with many floating point formats. Furthermore, aspects of the present disclosure may enable learning an exponent bias value, as well as an improved trade-off between a number of exponent bits and mantissa bits without manual intervention. Thus, aspects of the present disclosure may beneficially provide for floating-point quantization that improves inference efficacy in comparison to integer quantization.

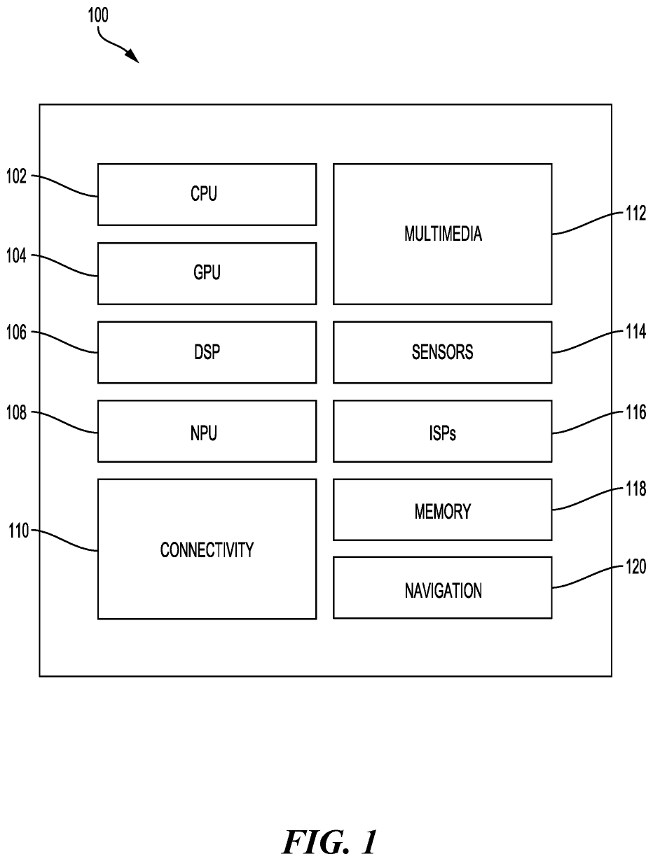

FIG. 1 illustrates an example implementation of a system-on-a-chip (SOC) 100, which may include a central processing unit (CPU) 102 or a multi-core CPU configured for eight-bit floating point simulation with learnable parameters. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to receive an input. The general-purpose processor 102 may also include code to perform an integer quantization process on the input. Each element of the input may be scaled based on a scaling parameter to generate an m-bit floating point input.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

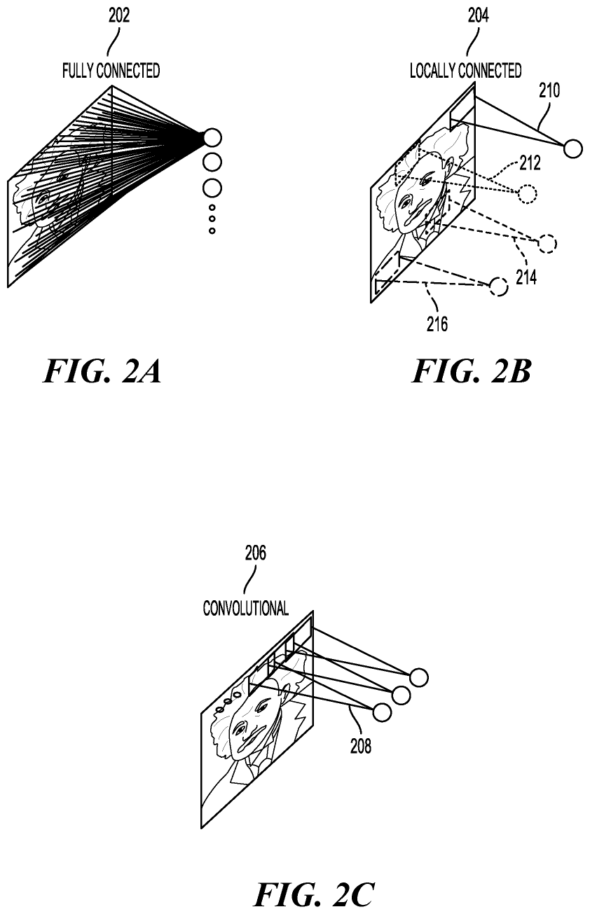

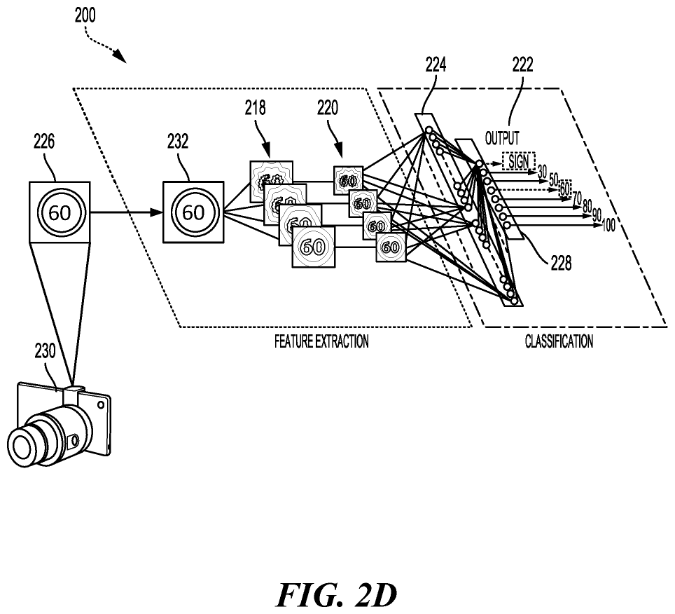

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as “stochastic gradient descent.” Stochastic gradient descent may be repeated until the achievable error rate of the entire system has stopped decreasing or until the error rate has reached a target level. After learning, the DCN 200 may be presented with new images and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

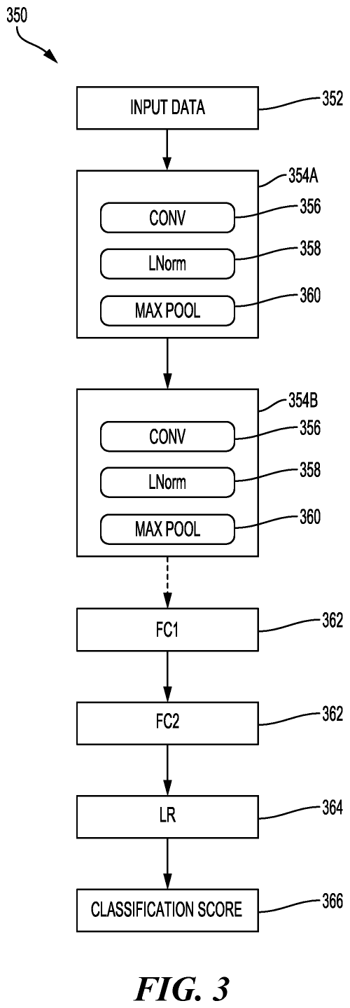

FIG. 3 is a block diagram illustrating a deep convolutional network (DCN) 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONN) 356, a normalization layer (LNorm) 358, and a max pooling layer (MAX POOL) 360. Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layers 360 may provide down sampling aggregation over space for local invariance and dimensionality reduction.

The parallel filter banks, for example, of a DCN may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

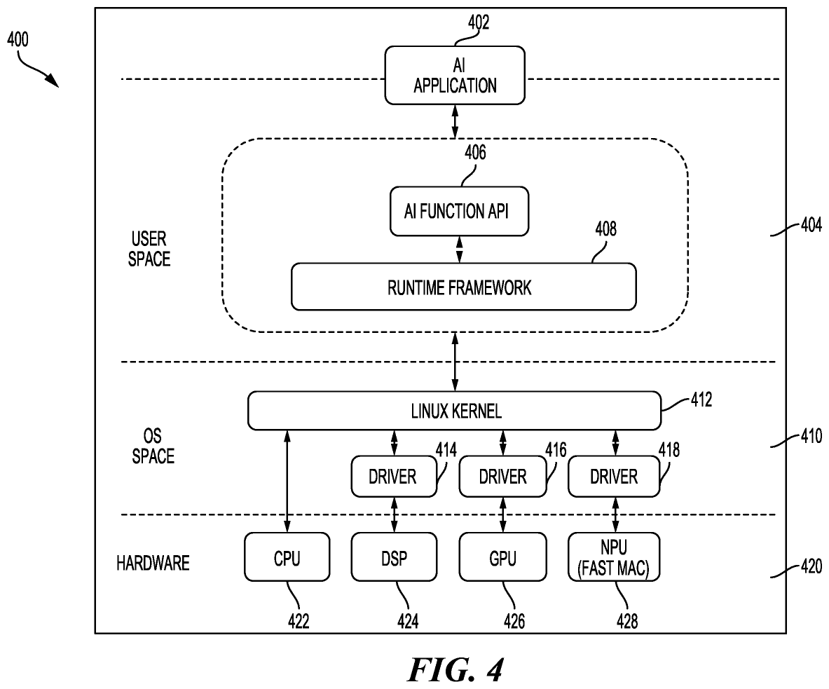

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) (which may be similar to SoC 100 of FIG. 1) to support floating point simulation for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

A run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a kernel 412, running on the SOC 420. In some examples, the Kernel 412 may be a Linux kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

The AI application 402 may be configured to call functions defined in the user space 404 that may, for example, provide for the detection and recognition of a scene indicative of the location in which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in a SceneDetect application programming interface (API) 406 to provide an estimate of the current scene. This request may ultimately rely on the output of a differential neural network configured to provide scene estimates based on video and positioning data, for example.

A run-time engine 408, which may be compiled code of a Runtime Framework, may be further accessible to the AI application 402. The AI application 402 may cause the run-time engine 408, for example, to request a scene estimate at a particular time interval or triggered by an event detected by the user interface of the AI application 402. When caused to estimate the scene, the run-time engine may in turn send a signal to the operating system 410, such as the Kernel 412, running on the SOC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as the driver 414-418 for the DSP 424, for the GPU 426, or for the NPU 428. In the exemplary example, the differential neural network may be configured to run on a combination of processing blocks, such as the CPU 422 and the GPU 426, or may be run on the NPU 428.

As described, aspects of the present disclosure are directed to an arbitrary bit-width simulation (e.g., eight-bit floating point (FP8) simulation) with learnable parameters. In accordance with aspects of the present disclosure, a floating point input x may be received. For instance, the input may comprise a single precision (e.g., 32-bit) floating point value. The input x may be received by an artificial neural network, for example. The input value is typically provided in a binary representation. The binary representation may include a sign bit, a mantissa, and an exponent. The mantissa refers to the binary digits of the floating point value and the exponent refers to binary digits indicating a number of positions to move the decimal point. An integer quantization operation with per element scaling may be performed on the input value. This operation is in contrast to conventional approaches that apply one scale for each channel or tensor. In some aspects, the scale s may be determined based on the number of mantissa bits, the closest integer power of two below the input, and a bias value.

Quantization may generally be applied to enable efficient integer matrix multiplications instead of 32-bit floating point (FP32) multiplications. This is because performing such computation involves a large memory consumption and latency. A matrix X∈R^{m×n} may be quantized to an integer matrix X ^{(int)} with an associated scale s as follows:

$${X}^{( int )} = clip ( ⌊ \frac{X}{s} ⌋ , {x}_{min} , {x}_{max} ) ,$$

where └. ┐ indicates the round-to-nearest operation, and clip (⋅,⋅,⋅) indicates the element-wise clipping operation, which ensures that X^{(int)} can be represented in a chosen bit-width. A dequantization operation may then produce a matrix X^{(q)} that is a quantized approximation of the input matrix X:X^{(q)}=sX^{(int)}≈X. The quantized approximation of the input matrix may enable the use of efficient integer matrix multiplication. For a matrix Y∈R^{n×k},

XY≈X^{(q)}Y^{(q)}=sₓs_{y}X^{(int)}Y^{(int)}. (1)

A floating point number set F⊂ [symbol] is a set whose elements are defined as follows:

$$f = {( - 1 )}^{s} {2}^{p - b} ( 1 + \frac{{d}_{1}}{2} + \frac{{d}_{2}}{{2}^{2}} + … \frac{{d}_{m}}{{2}^{m}} ) , \qquad ( 2 )$$

where s∈{0, 1} is a sign bit, dᵢ∈{0,1} is an m-bit mantissa, p∈ [symbol] ; 0 <p <2^{e} is an e-bit exponent, and b is an integer exponent bias that may be defined to be 2^{e-1}

Floating point numbers may be seen as a uniform m-bit grid between two consecutive (integer) powers of two 2^{a},2^{a+1} The distance between grid points in the range [2^{a},2^{a+1}] is 2^{a-m}. Increasing the number of mantissa bits thus increases the number of grid points in each range [2^{a},2^{a+1}]. In the definition provided, the number of ranges [2^{a},2^{a+1}] that may be represented by a floating point number system is determined by the number of exponent bits e. Increasing the number of exponent bits may increase the dynamic range (e.g., ratio between largest and smallest non-zero value) of values that may be represented. A fixed bit-width floating point number system makes a trade-off between the dynamic range of representable values (e), and the precision (m). For example, IEEE-754 32-bit ‘full-precision’ floating point numbers (FP32) use one sign bit, 23 mantissa bits, and eight exponent bits. The resulting effect is that compared to integer formats, floating point formats have more precision close to zero, as the ranges [2^{a},2^{a+1}] is smaller for lower values of a, and less precision away from zero. Intuitively, the floating point formats are a better match for peaked distributions such as Gaussians that have more density around zero, and a better fit for distributions with large tails and outliers like the Student's t-distribution.

Note that this definition does not allow for a representation of zero. To enable zero to be represented, the exponent value p=0 may be reserved to indicate subnormal numbers. In this case, the exponent value may be implicitly set to one, and

$$f = {( - 1 )}^{{s}_{2} 1 - b} ( 0 + \frac{{d}_{1}}{2} + \frac{{d}_{2}}{{2}^{2}} + … \frac{{d}_{m}}{{2}^{m}} ) .$$

Besides enabling the exact representation of zero, subnormal numbers may also enable a more graceful representation of values close to zero. That is, without the subnormal range, there would be a gap between −2^{-b} and 2^{-b} in the values that could be represented including the value zero. Thus, aspects of the present disclosure may beneficially enable a more complete representation of values that reduce, and may, in some aspect, eliminate a gap in the subnormal range and may increase model accuracy.

Additionally, in accordance with aspects of the present disclosure, a (per-tensor or per-channel) quantization scale y may be provided. Because there may be no standard allocation of mantissa and exponent bits for floating point formats, various allocations of mantissa and exponent bits may be considered, as the choice of trade-offs between precision and dynamic range may have more impact for lower floating point bit-widths.

Aspects of the present disclosure may exploit floating point quantization as a union of m-bit uniform quantization grids between consecutive integer powers of two [2^{a},2^{a+1}]. As such, floating point quantization (e.g., FP8) of an input vector x may be simulated by associating a scale sᵢ with each element xᵢ in x:

$${x}_{i}^{( q )} = {s}_{i} ⌊ \frac{{x}_{i}}{{s}_{i}} ⌉ , \qquad ( 3 )$$

where xᵢ^{(q)} denotes xᵢ quantized to a floating point. The scale sᵢ may depend on the number of mantissa bits m and the range [2^{a},2^{a+1}] in which xᵢ falls. Thus, the scale sᵢ may be given by:

log₂sᵢ=pᵢ=└log₂|xᵢ|┐−m. (4)

In some aspects, values of xᵢ^{(q)} and sᵢ may be clipped to ensure that xᵢ^{(q)} can be represented given m, e, and b. For example, values of xᵢ^{(q)} greater than a maximum value c or smaller than −c may be clipped at c and −c respectively, where c=(2−2^{-m})2²^{^{e−b−1}} is the largest representable value for a given floating point format. Because 2^{1-b-m} is the smallest representable value, values of pᵢ smaller than 1−b−m may be clipped to 1−b−m.

In some aspects, the quantization scaling factor may be applied (e.g., the quantization scaling factor γ≠1). In this case, pᵢ may be adapted. For instance, in order to accommodate the quantization scaling factor γ, it may be folded into a re-parameterized bias value \hat{b}=b−log₂ γ. Accordingly, pᵢ may be computed as given by:

$${p}_{i} \{ \begin{matrix}⌊ {log}_{2} \vert {x}_{i} \vert + \hat{b} ⌋ - \hat{b} - m , & if ⌊ {log}_{2} \vert {x}_{i} \vert + b ⌋ > 1 \\ 1 - \hat{b} - m , & otherwise .\end{matrix} \qquad ( 5 )$$

Additionally, aspects of the present disclosure may be applied to enable quantization aware training (QAT). In QAT, rather than computing a scaling factor after a neural network is trained, a quantization error may be used for training the neural network and in doing so, scales the neural network parameters. A straight-through estimator (STE) for gradients of non-differentiable rounding operations may be used to enable gradients to flow through each step of the quantizer. Furthermore, a maximum clipping value c may be learned rather than \hat{b} to improve training stability. Then \hat{b} may be determined based on the maximum clipping value c as expressed:

\hat{b}=2^{e}−log₂c−log₂ (2−2^{-└m┐})+1 (6)

The value └log₂|xᵢ|+\hat{b}┐ may be treated as a constant that receives no gradient. Doing so may prevent the (sometimes extremely large) gradients of this operation with respect to xᵢ to propagate backwards. Thus, x receives the ‘straight-through’ gradient for a full quantization procedure, for example,

$$\frac{\partial }{\partial {x}_{i}} F ( {x}_{i} , m , c ) = 1 ,$$

where F(⋅,⋅,⋅) denotes the floating point quantizer.

Accordingly, aspects of the present disclosure provide floating pointing quantization with an adaptable bit-width that may beneficially yield better tensor reconstruction than integer (e.g., INT8) quantization, with selection of the division between exponent and mantissa bits, as well as the value of the exponent bias. Moreover, aspects of the present disclosure may be implemented in common deep learning frameworks and may beneficially expose the parameters of the floating point (e.g., FP8) quantizer (e.g., the number of mantissa bits, the exponent, and the exponent bias), thus enabling these parameters to be learned via back-propagation.

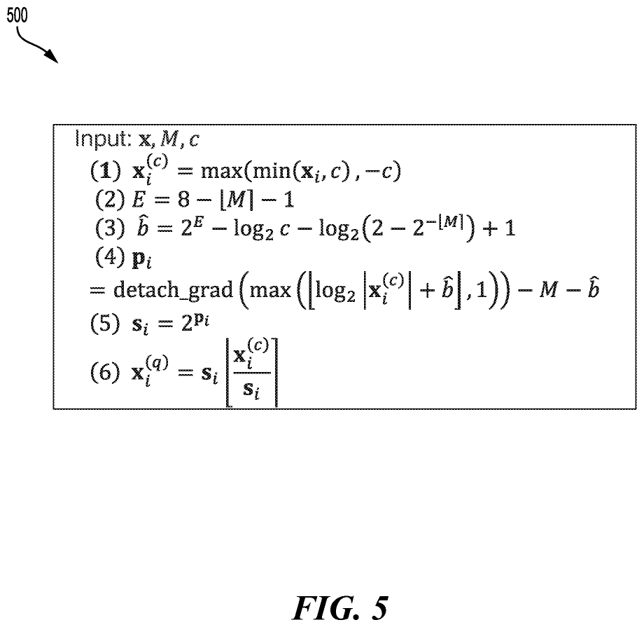

FIG. 5 is a block diagram illustrating example pseudo code 500, in accordance with aspects of the present disclosure. Referring to FIG. 5, the example pseudo code 500 provides that an input x for a neural network may be received. The input may, for example, comprise a floating point value, such as a 32-bit floating point number. The input x may be represented in a binary format such that the floating point value is represented via a number of mantissa bits M. Additionally, a maximum input clipping value c may be determined (or indicated).

A learnable clipping value c may be determined. Using the maximum clipping value c, a range of values of the input x may be determined. At line 2, a number of exponent bits E may be redefined as a function of the mantissa bits M, where M is made learnable. At line 3, a re-parameterized bias value \hat{b} may be determined based on the learned maximum clipping value c. At line 4, the number of exponent bits for the FP8 may be determined based on the learned mantissa bits M and the re-parameterized bias value \hat{b}. At line 5, a scale s may be computed. The scale s corresponds to the grid defined by the learnable mantissa bits M and clipping value c. Finally, at line 6, the input x may be quantized (e.g., xᵢ^{(q)}) with the scale s.

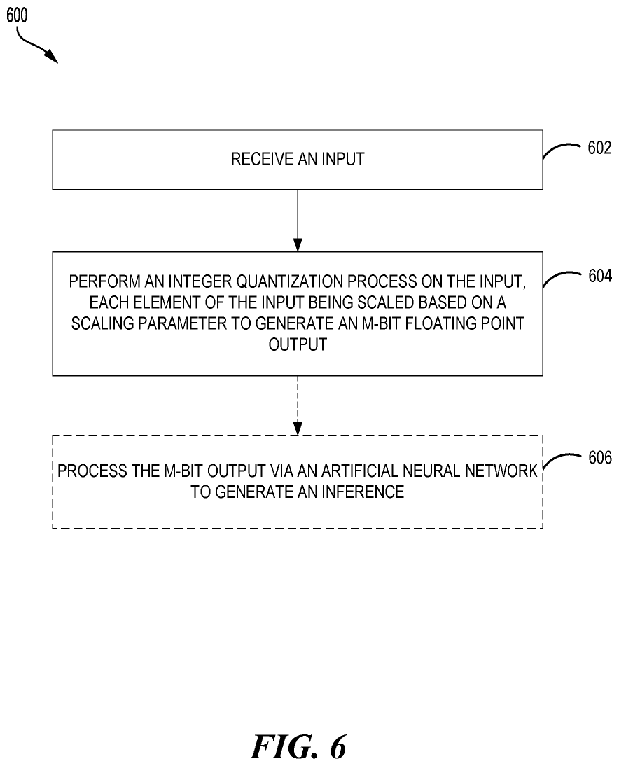

FIG. 6 is a flow diagram illustrating a processor-implemented method 600 for floating point simulation with learnable parameters, in accordance with aspects of the present disclosure. The processor-implemented method 600 may be performed by a processor such as the CPU 102, the NPU 108, or other processing device for example. As shown in FIG. 6, at block 602, the processor receives an input. As described, an input x may be received. The input may comprise a floating point value. For instance, the input may comprise a single precision (e.g., 32-bit) floating point value. The input x may be received via the artificial neural network, for example.

At block 604, the processor performs an integer quantization process on the input. Each element of the input may be scaled based on a scaling parameter to generate an m-bit floating point output. For instance, FP8 quantization of an input vector x may be simulated by associating a scale sᵢ with each element xᵢ in x. The scale sᵢ may depend on the number of mantissa bits m and the range [2^{a},2^{a+1}] in which xᵢ falls. Thus, the FP8 quantization may exploit a union of m-bit uniform quantization grids between consecutive integer powers of two [2^{a},2^{a+1}] Furthermore, in some aspects, a straight-through estimator (STE) for gradients of non-differentiable rounding operations may be used to enable gradients to flow through each step of the quantizer.

At block 606, the processor may optionally process the m-bit floating point (e.g., FP8) output via an artificial neural network to generate an inference. For instance, the inference may provide an indication of a classification of the input.

Although, the example outputs described are in an eight-bit floating point format, the present disclosure is not so limiting. Rather, in accordance with aspects of the present disclosure arbitrary floating point formats may be simulated.

### Example Aspects

Aspect 1: A processor-implemented method comprising: receiving an input; and performing an integer quantization process on the input, each element of the input being scaled based on a scaling parameter to generate an m-bit floating point output, where m is an integer.

Aspect 2: The processor-implemented method of Aspect 1, further comprising processing the m-bit floating point output via an artificial neural network to generate an inference.

Aspect 3: The processor-implemented method of Aspect 1 or 2, in which the scaling parameter is determined based on a first number of mantissa bits, a nearest integer power of two below the input, and an exponent bias.

Aspect 4: The processor-implemented method of any of Aspects 1-3, in which the exponent bias is a floating point value.

Aspect 5: The processor-implemented method of any of Aspects 1-4, further comprising determining a range of m-bit floating point values represented in a quantization grid based on a first number of mantissa bits, a second number of exponent bits, and a bias value.

Aspect 6: The processor-implemented method of any of Aspects 1-5, in which the range of m-bit floating point values and the first number of mantissa bits are learnable parameters, the second number of exponent bits is determined from the first number of mantissa bits, and the bias value is determined from the range of m-bit floating point values, the first number of mantissa bits, and the second number of exponent bits.

Aspect 7: The processor-implemented method of any of Aspects 1-6, in which the m-bit floating point output comprises an eight-bit floating point output.

Aspect 8: The processor-implemented method of any of Aspects 1-7, in which the input is a single precision 32-bit value.

Aspect 9: An apparatus, comprising: a memory; and at least one processor coupled to the memory, the at least one processor configured to: receive an input; and perform an integer quantization process on the input, each element of the input being scaled based on a scaling parameter to generate an m-bit floating point output, where m is an integer.

Aspect 10: The apparatus of Aspect 9, in which the at least one processor is further configured to process the m-bit floating point output via an artificial neural network to generate an inference.

Aspect 11: The apparatus of Aspect 9 or 10, in which the at least one processor is further configured to determine the scaling parameter is based on a first number of mantissa bits, a nearest integer power of two below the input, and an exponent bias.

Aspect 12: The apparatus of any of Aspects 9-11, in which the exponent bias is a floating point value.

Aspect 131: The apparatus of any of Aspects 9-12, in which the at least one processor is further configured to determine a range of m-bit floating point values represented in a quantization grid based on a first number of mantissa bits, a second number of exponent bits, and a bias value.

Aspect 14: The apparatus of any of Aspects 9-13, in which the range of m-bit floating point values and the first number of mantissa bits are learnable parameters, the second number of exponent bits is determined from the first number of mantissa bits, and the bias value is determined from the range of m-bit floating point values, the first number of mantissa bits, and the second number of exponent bits.

Aspect 15: The apparatus of any of Aspects 9-14, in which the m-bit floating point output comprises an eight-bit floating point output.

Aspect 16: The apparatus of any of Aspects 9-15, in which the input is a single precision 32-bit value and the m-bit floating point output comprises an eight-bit floating point output.

Aspect 17: A non-transitory computer-readable medium having program code recorded thereon, the program code executed by a processor and comprising: program code to receive an input; and program code to perform an integer quantization process on the input, each element of the input being scaled based on a scaling parameter to generate an m-bit floating point output, where m is an integer.

Aspect 18: The non-transitory computer-readable medium of Aspect 17, further comprising program code to process the m-bit floating point output via an artificial neural network to generate an inference.

Aspect 19: The non-transitory computer-readable medium of Aspect 17 or 18, further comprising program code to determine the scaling parameter based on a first number of mantissa bits, a nearest integer power of two below the input, and an exponent bias.

Aspect 20: The non-transitory computer-readable medium of any of Aspects 17-19, in which the exponent bias is a floating point value.

Aspect 21: The non-transitory computer-readable medium of any of Aspects 17-20, further comprising program code to determine a range of m-bit floating point values represented in a quantization grid based on a first number of mantissa bits, a second number of exponent bits, and a bias value.

Aspect 22: The non-transitory computer-readable medium of any of Aspects 17-21, in which the range of m-bit floating point values and the first number of mantissa bits are learnable parameters, the second number of exponent bits is determined based on the first number of mantissa bits, and the bias value is determined based on the range of m-bit floating point values, the first number of mantissa bits, and the second number of exponent bits.

Aspect 23: The non-transitory computer-readable medium of any of Aspects 17-22, in which the m-bit floating point output comprises an eight-bit floating point output.

Aspect 24: The non-transitory computer-readable medium of any of Aspects 17-23, in which the input is a single precision 32-bit value and the m-bit floating point output comprises an eight-bit floating point output.

Aspect 25: An apparatus for processor-implemented method, comprising: means for receiving an input; and means for performing an integer quantization process on the input, each element of the input being scaled based on a scaling parameter to generate an m-bit floating point output, where m is an integer.

Aspect 26: The apparatus of Aspect 25, further comprising means for processing the m-bit floating point output via an artificial neural network to generate an inference.

Aspect 27: The apparatus of Aspect 25 or 26, further comprising means for determining the scaling parameter based on a first number of mantissa bits, a nearest integer power of two below the input, and an exponent bias.

Aspect 28: The apparatus of any of Aspects 25-27, further comprising means for determining a range of m-bit floating point values represented in a quantization grid based on a first number of mantissa bits, a second number of exponent bits, and a bias value.

Aspect 29: The apparatus of any of Aspects 25-28, in which the range of m-bit floating point values and the first number of mantissa bits are learnable parameters, the second number of exponent bits is determined from the first number of mantissa bits, and the bias value is determined from the range of m-bit floating point values, the first number of mantissa bits, and the second number of exponent bits.

Aspect 30: The apparatus of any of Aspects 25-28, in which the m-bit floating point output comprises an eight-bit floating point output.

In one aspect, the receiving means, performing means, defining means, and/or applying means may be the GPU 104, program memory associated with the GPU 104, fully connected layers 362, NPU 428 and or the routing connection processing unit 216 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A processor-implemented method comprising:
receiving an input; and
performing an integer quantization process on the input, each element of the input being scaled based on a scaling parameter to generate an m-bit floating point output, where m is an integer.

2. The processor-implemented method of claim 1, further comprising processing the m-bit floating point output via an artificial neural network to generate an inference.

3. The processor-implemented method of claim 1, in which the scaling parameter is determined based on a first number of mantissa bits, a nearest integer power of two below the input, and an exponent bias.

4. The processor-implemented method of claim 3, in which the exponent bias is a floating point value.

5. The processor-implemented method of claim 1, further comprising determining a range of m-bit floating point values represented in a quantization grid based on a first number of mantissa bits, a second number of exponent bits, and a bias value.

6. The processor-implemented method of claim 5, in which the range of m-bit floating point values and the first number of mantissa bits are learnable parameters, the second number of exponent bits is determined from the first number of mantissa bits, and the bias value is determined from the range of m-bit floating point values, the first number of mantissa bits, and the second number of exponent bits.

7. The processor-implemented method of claim 1, in which the m-bit floating point output comprises an eight-bit floating point output.

8. The processor-implemented method of claim 1, in which the input is a single precision 32-bit value.

9. An apparatus, comprising:
a memory; and
at least one processor coupled to the memory, the at least one processor configured to:
receive an input; and
perform an integer quantization process on the input, each element of the input being scaled based on a scaling parameter to generate an m-bit floating point output, where m is an integer.

10. The apparatus of claim 9, in which the at least one processor is further configured to process the m-bit floating point output via an artificial neural network to generate an inference.

11. The apparatus of claim 9, in which the at least one processor is further configured to determine the scaling parameter is based on a first number of mantissa bits, a nearest integer power of two below the input, and an exponent bias.

12. The apparatus of claim 11, in which the exponent bias is a floating point value.

13. The apparatus of claim 9, in which the at least one processor is further configured to determine a range of m-bit floating point values represented in a quantization grid based on a first number of mantissa bits, a second number of exponent bits, and a bias value.

14. The apparatus of claim 13, in which the range of m-bit floating point values and the first number of mantissa bits are learnable parameters, the second number of exponent bits is determined from the first number of mantissa bits, and the bias value is determined from the range of m-bit floating point values, the first number of mantissa bits, and the second number of exponent bits.

15. The apparatus of claim 9, in which the m-bit floating point output comprises an eight-bit floating point output.

16. The apparatus of claim 9, in which the input is a single precision 32-bit value and the m-bit floating point output comprises an eight-bit floating point output.

17. A non-transitory computer-readable medium having program code recorded thereon, the program code executed by a processor and comprising:
program code to receive an input; and
program code to perform an integer quantization process on the input, each element of the input being scaled based on a scaling parameter to generate an m-bit floating point output, where m is an integer.

18. The non-transitory computer-readable medium of claim 17, further comprising program code to process the m-bit floating point output via an artificial neural network to generate an inference.

19. The non-transitory computer-readable medium of claim 17, further comprising program code to determine the scaling parameter based on a first number of mantissa bits, a nearest integer power of two below the input, and an exponent bias.

20. The non-transitory computer-readable medium of claim 19, in which the exponent bias is a floating point value.

21. The non-transitory computer-readable medium of claim 17, further comprising program code to determine a range of m-bit floating point values represented in a quantization grid based on a first number of mantissa bits, a second number of exponent bits, and a bias value.

22. The non-transitory computer-readable medium of claim 21, in which the range of m-bit floating point values and the first number of mantissa bits are learnable parameters, the second number of exponent bits is determined based on the first number of mantissa bits, and the bias value is determined based on the range of m-bit floating point values, the first number of mantissa bits, and the second number of exponent bits.

23. The non-transitory computer-readable medium of claim 17, in which the m-bit floating point output comprises an eight-bit floating point output.

24. The non-transitory computer-readable medium of claim 17, in which the input is a single precision 32-bit value and the m-bit floating point output comprises an eight-bit floating point output.

25. An apparatus for processor-implemented method, comprising:
means for receiving an input; and
means for performing an integer quantization process on the input, each element of the input being scaled based on a scaling parameter to generate an m-bit floating point output, where m is an integer.

26. The apparatus of claim 25, further comprising means for processing the m-bit floating point output via an artificial neural network to generate an inference.

27. The apparatus of claim 25, further comprising means for determining the scaling parameter based on a first number of mantissa bits, a nearest integer power of two below the input, and an exponent bias.

28. The apparatus of claim 25, further comprising means for determining a range of m-bit floating point values represented in a quantization grid based on a first number of mantissa bits, a second number of exponent bits, and a bias value.

29. The apparatus of claim 28, in which the range of m-bit floating point values and the first number of mantissa bits are learnable parameters, the second number of exponent bits is determined from the first number of mantissa bits, and the bias value is determined from the range of m-bit floating point values, the first number of mantissa bits, and the second number of exponent bits.

30. The apparatus of claim 25, in which the m-bit floating point output comprises an eight-bit floating point output.
